(19) United States
(12) Patent Application Publication
(10) Pub. No.: US 2014/0311688 A1
(43) Pub. Date: Oct. 23, 2014

(54) CLAD SLAT

(71) Applicant: J. I. PELED LTD., Rosh Ha'ain (IL)

(72) Inventors: Jossi Peled, Rosh Ha'ain (IL); Rivi Peled, Rosh Ha'ain (IL); Vered Peled, Rosh Ha'ain (IL)

(21) Appl. No.: 14/357,823

(22) PCT Filed: Oct. 31, 2012
(86) PCT No.: PCT/IL2012/050428

§ 371 Date: May 13, 2014

(30) Foreign Application Priority Data
Nov. 14, 2011 (IL) 216354

(51) Int. Cl. E06B 9/386

(52) U.S. Cl. CPC E06B 9/386
USPC 160/236; 29/428

(57) ABSTRACT

The present disclosure provides a slat that may be capable of being used in a shutter. The slat may include a core having at least one groove. The at least one groove may be configured along a length of the core. In an embodiment, the core may be made up of a wooden material, a synthetic material, and the like. The slat may further include a cladding having at least one extension. The cladding may be configured to conform to the core. Further, the at least one extension may be configured to be received by the at least one groove. In a preferred embodiment, the cladding may be made up of a weather-resistant material.

### BACKGROUND OF THE DISCLOSURE

1. Field of Disclosure

The present disclosure may relate to clad articles comprising a core and partial and/or full cladding, and, more specifically, to a clad slat for use as a component, for example in a shutter assembly.

2. Description of the Related Art

Generally, slats are used in various forms of coverings for architectural openings such as a shutter, a shade, a window, a blind, and/or the like. Slats may be suspended by a plurality of means. A typical slat includes a core and a cladding. The core may be made up of a variety of materials, including, but not limited to, wooden materials, thermoplastic materials, foam, and/or the like. The cladding may be a sheath partially and/or fully enclosing the core. Conventionally, the core and the cladding are assembled together by using an additional component such as a sealing, an adhesive, glue, a connector clip, and/or the like. Accordingly, the quality of the slat may get affected. Therefore, there exists a need of an improved method of assembling the core and the cladding.

### SUMMARY OF THE DISCLOSURE

The present disclosure provides a slat that may be capable of being used as a component (for example, in an assembly). The slat includes a core having one or more grooves. Further, the one or more grooves may be configured along a particular length of the core. In an embodiment, the core may be made up of a wooden material, a synthetic material, and/or the like. The slat further includes a cladding having one or more extensions. The cladding is configured so as to conform to the core of the slat. Further, the one or more extensions are configured in order to fit into the one or more respective grooves. In a preferred embodiment, the cladding of the slat may be made up of a weather-resistant material.

In another embodiment, the cladding may be made up of a sheet of a material selected from a group consisting of plastic, polyvinyl chloride (PVC), acrylic, polycarbonate, and composites thereof and/or the like. The cladding may further be made up of an aluminum material. In further embodiment, the cladding may be fixed in to the grooves of the core with a little or no space therebetween. Accordingly, the cladding and the core may be snuggly fitted together to form a tight fixation without requiring any additional component.

In another aspect, the present disclosure provides a method of preparing a slat for a shutter. The method may include providing one or more grooves in the core of the slat. The grooves may be provided along a length of the core. In an embodiment, the core may be made up of a wooden material, a synthetic material, and/or the like. The method may further include providing one or more extensions in the cladding. In an embodiment, the cladding may be made up of a weather-resistant material. In another embodiment, the cladding may be made up of a sheet of a material selected from the group consisting of metals, plastic, composite, polyvinyl chloride (PVC), acrylic, polycarbonate, and/or the like.

Further, the method includes placing the cladding over the core in such a way that the extensions of the cladding fit in the grooves of the core.

### BRIEF DESCRIPTION OF THE FIGURES

The foregoing and other aspects, features and advantages will be more apparent from the following more particular description of the preferred embodiments of the disclosure as shown in the accompanying drawings:

FIG. 1a schematically illustrates a lateral cross-section view of a core and a cladding of a slat, before assembly, in accordance with a possible embodiment of the present disclosure;

FIG. 2aa schematically illustrates a cross-section view of the slat shown in FIG. 1a, with the core and the cladding in an assembled form;

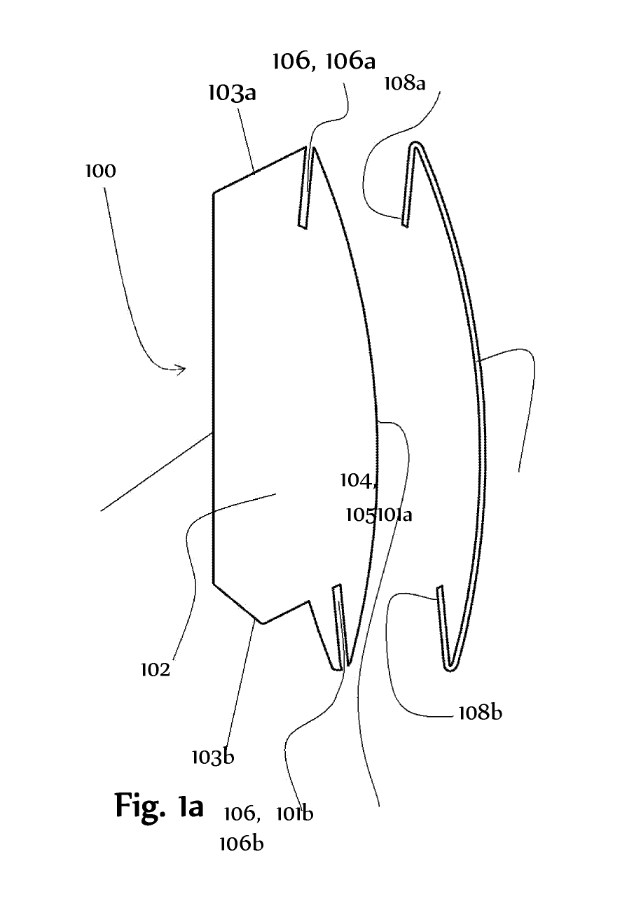

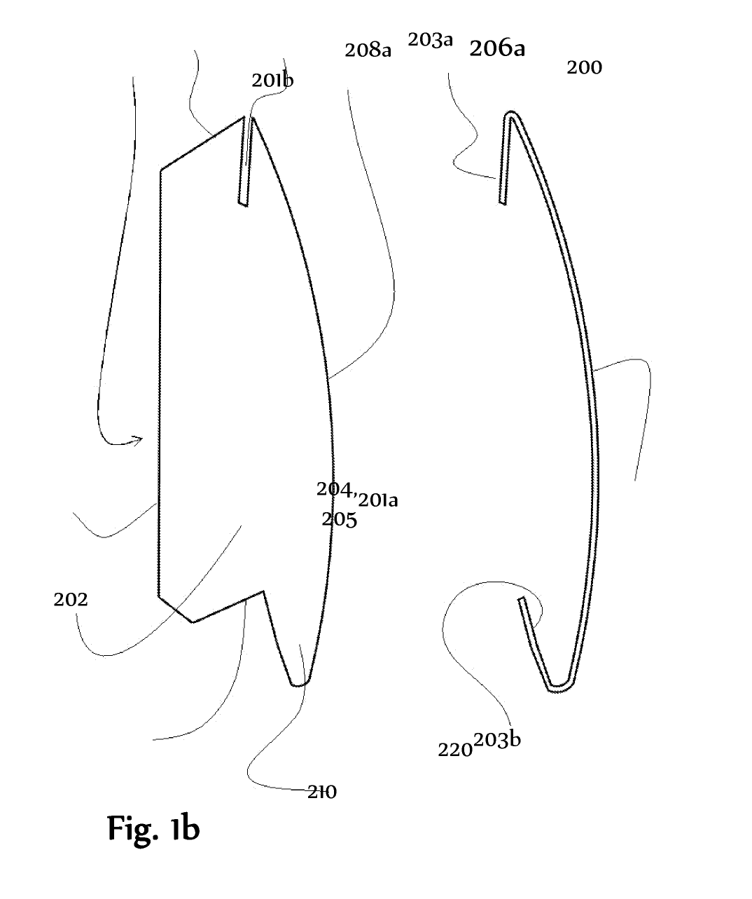

FIG. 1b schematically illustrates a lateral cross-section view of a core and a cladding of a slat, before assembly, in accordance with another possible embodiment of the present disclosure;

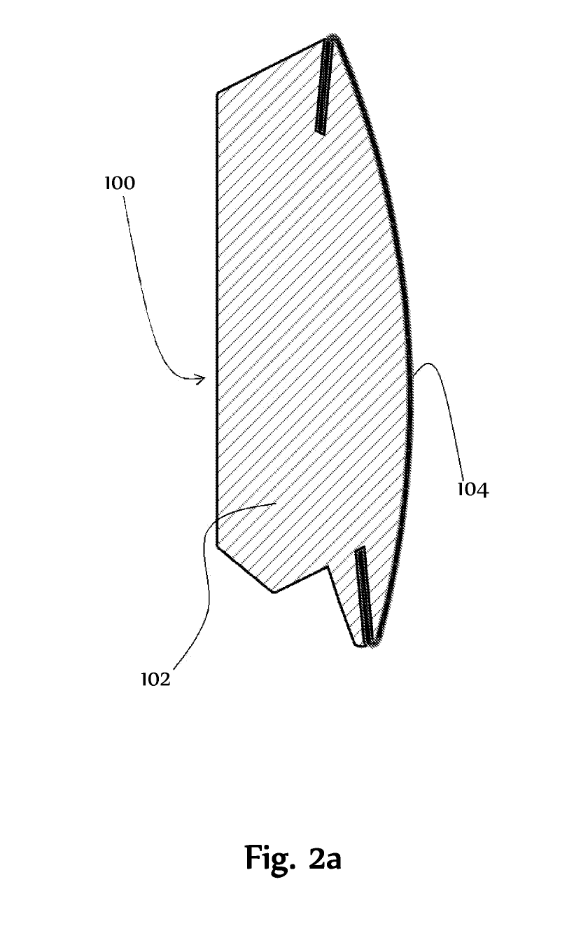

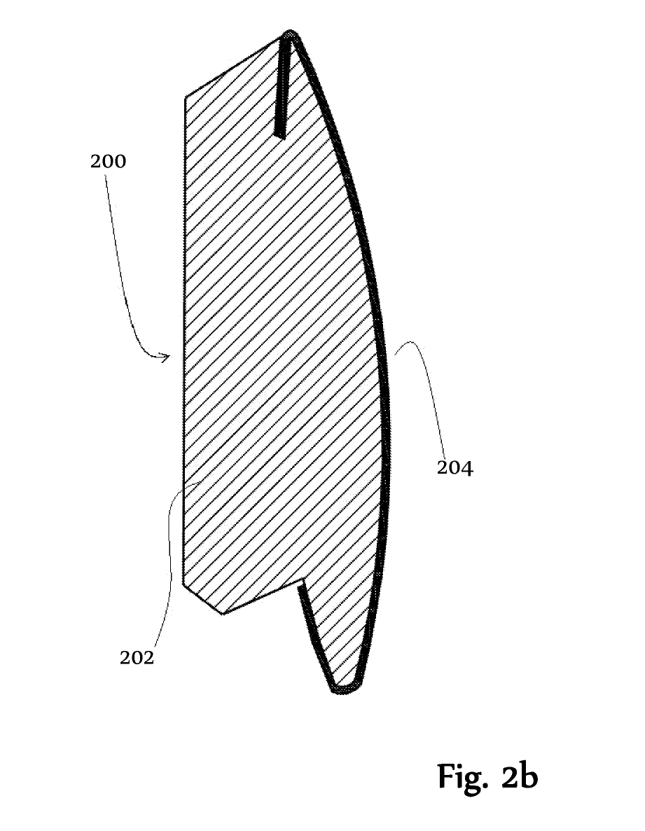

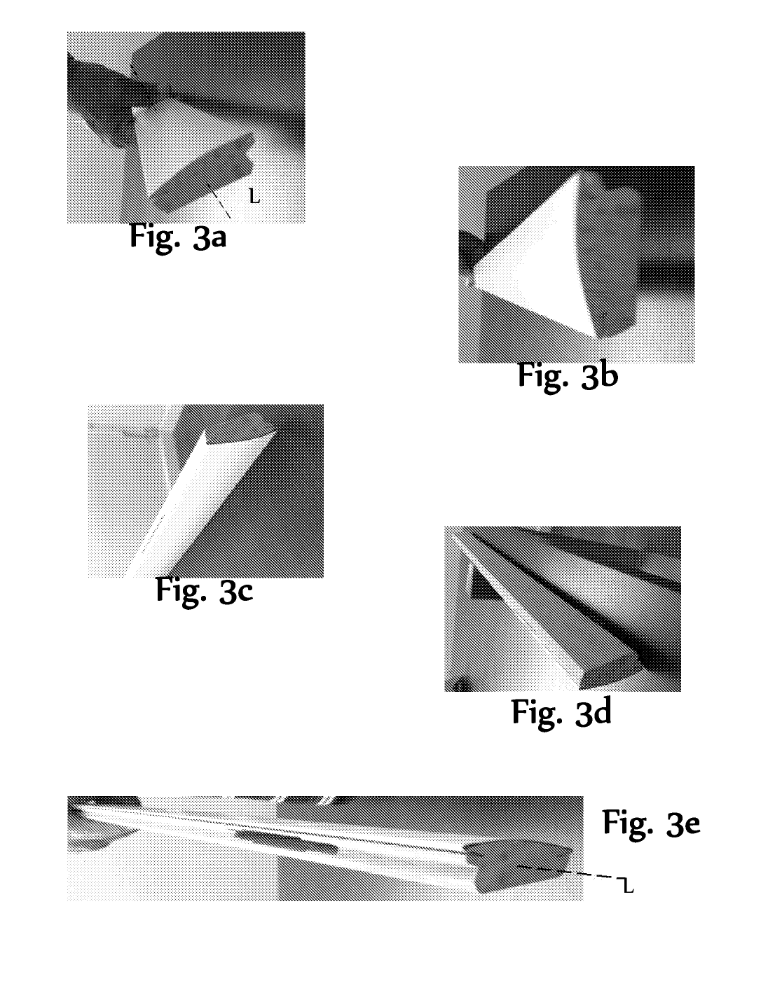

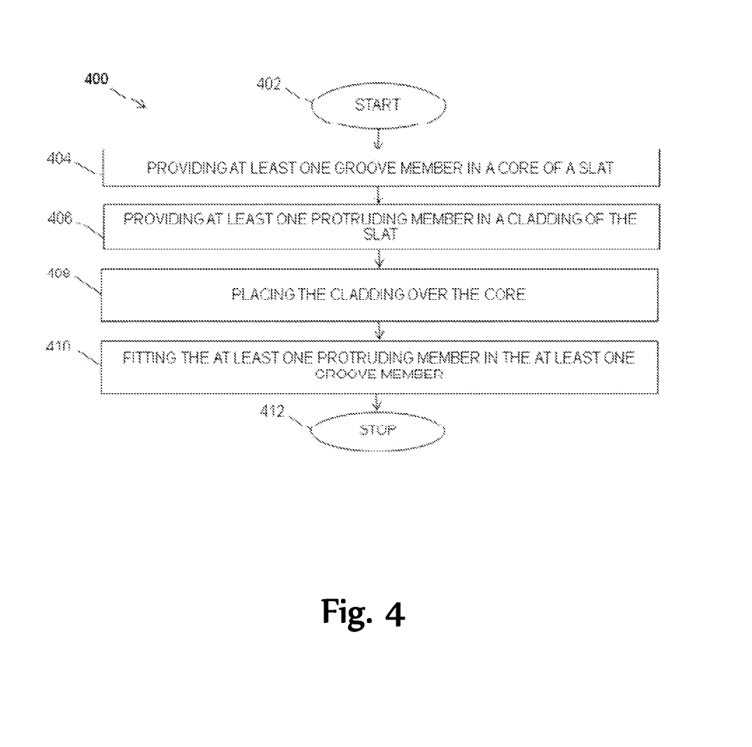

FIG. 2b schematically illustrates a cross-section view of the slat shown in FIG. 1b, with the core and the cladding in an assembled form;

FIGS. 3A-3E depict various perspective views of the core and the cladding in the assembled form, in accordance with the embodiment of the present disclosure; and

FIG. 4 schematically illustrates a flow diagram of a method for preparing a slat, in accordance with an embodiment of the present disclosure.

### DETAILED DESCRIPTION

Embodiments of the present disclosure are disclosed herein; however, it is to be understood that the disclosed embodiments are merely exemplary of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Further, the terms and phrases used herein are not intended to be limiting, but rather to provide an understandable description of the disclosure.

The terms “a” or “an,” as used herein, are defined as one, or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and/or physically.

The present disclosure provides an article having a core and a full and/or partial cladding that is configured to conform to an external outline of the core. The core may be provided with at least one groove. The cladding may include at least one extension configured to be received by the longitudinal groove. In addition, the core and the cladding may be snuggly fitted together without any requirement of an additional component, possibly, as an illustrative example only, by sliding one of the core and/or cladding relative to the other one of the core and/or the cladding. The present disclosure may also disclose a method of preparing the slat as mentioned above.

Referring to FIG. 1a, a schematic cross-sectional view of an exemplary slat 100 with a core 102 and a partial cladding 104 is schematically illustrated, in accordance with an exemplary embodiment of the present disclosure. The exemplary slat 100 may have a generally rectangular cross sectional shape and may be provided in various sizes. Further, the core 102 may be made up of a wooden material, a synthetic material, and/or the like. In an example, the core 102 may be made up of a finger jointed wood. Other materials that may be used in place of wood for the core 102 of the exemplary slat 100 may include multi-dimensional fiberboard, particle board, wheatboard, products such as polystyrene with or without pelletized wood flour, foamed Poly Vinyl Chloride (PVC), rigid vinyl slats, and/or the like.

In an optional form, the core 102 may be laminated from a plurality of wood strips bonded together. In an alternative form, the core 102 may be provided by a plurality of wood chips bonded together. The wood may be selected on the basis of desired strength, durability, cost, and/or the like. Further, the core 102 may be pressure-treated with borates or other non-hazardous substances, and dried in a kiln or other device to proper moisture, as may be desired. It will be evident to a person skilled in the art that the core may be formed by any of a plurality of known and/or discovered means, from any appropriate known and/or discovered material.

The core 102 extends longitudinally (i.e., perpendicularly to the cross-sectional view shown on FIGS. 1a and 2a) and comprises generally longitudinally-extending, opposing first flank 103a and second flank 103b extending between, and connecting generally longitudinally-extending, opposing, base 101a and top 101b. The first and second flanks 103a, 103b of the core 102 may be provided each with a generally longitudinally-extending first groove 106a and a second groove 106b, respectively.

In one or more embodiments, the cladding 104 as shown in the FIG. 1a may be made as a thin strip and/or a long and narrow sheet, bent to shape. The cladding 104 may include a plurality of extensions 108 such as a first extension 108a and a second extension 108b. The cladding 104 may extend away from the plurality of extensions 108 to form a cladding body 105. In an embodiment, the cladding 104 may be placed on the core 102 for weather protection, visually-pleasing effects, and/or durability. As an illustrative-only example, the cladding 104 may be provided by a sheet of a material selected from the group consisting of plastic, PVC, acrylic, polycarbonate, and composites thereof, and/or veneers, including, but not limited to, wood veneers, and/or may be formed of metal, including, but not limited to, copper, aluminum, bronze, brass or similar. However, it will be evident to a person skilled in the art that the cladding 104 may be made up of any other material or process known in the art. Further, the cladding 104 may be rolled or laid onto the core 102 by any applicable known and/or discovered way or method. The cladding 104 may be configured to conform to an external outline of the core 102 of the exemplary slat 100.

Referring to FIG. 2a, a perspective view of the exemplary slat 100 with the core 102 and the cladding 104 in an assembled form is schematically illustrated, in accordance with an embodiment of the present disclosure. The exemplary slat 100 may be assembled by placing and/or drawing the cladding 104 relative to the core 102. Specifically, the cladding 104 may be placed such that the plurality of extensions 108 may be configured to be received by the plurality of grooves 106. The cladding 104 may be impressioned upon the core 102 of the exemplary slat 100. In an embodiment, the cladding 104 may be held by the plurality of grooves 106 of the core 102 with little or no space therebetween. Further, the cladding 104 and the core 102 may be rather snuggly fitted together without requiring any additional component, fastener or intervening substances, such as glues.

FIGS. 1b and 2b illustrate a modified, exemplary embodiment of the present disclosure. A modified slat 200 is schematically illustrated. The modified slat 200 embodiment may include many features that are similar to the exemplary slat 100 schematically illustrated on FIGS. 1a and 2a. Similar features for the modified slat 200 have been given reference numerals that are the reference numerals used for the exemplary slat 100 increased by 100.

Referring to FIG. 1b, a lateral cross-sectional view of the modified slat 200 with a core 202 and a partial cladding 204 is schematically illustrated, in accordance with an exemplary embodiment of the present disclosure. The modified slat 100 may have a generally rectangular cross sectional shape and may be provided in various sizes. Similar wide variety of materials may be used for making the modified slat 200 as those for making the exemplary slat 100. Further, the core 202 may be made up of a wooden and/or wood-based material, a synthetic material, and/or the like. As an illustrative-only example, the core 202 may be made up of a finger jointed wood.

The core 202 of the modified slat 200 extends longitudinally (i.e., perpendicularly to the cross-sectional view shown on FIGS. 1b and 2b) and comprises generally longitudinally-extending, opposing first flank 203a and second flank 203b extending between, and connecting generally longitudinally-extending, opposing, base 201a and top 201b. The first flank 203a may be provided with a generally longitudinally-extending first groove 206a, while the second flank 203b may be provided with an overhang 210 extending generally longitudinally along, as well as laterally away from, the second flank 203b.

In one or more embodiments, the cladding 204 as shown in the FIG. 1b may be made as a thin strip. The cladding 204 may include a first extension 208a and an opposing hook 220. The cladding 204 may extend away from the first extension 208a towards the hook 220. In an embodiment, the cladding 204 may be located on the core 202 for weather protection and durability. The cladding 204 of the modified slat 200 may include similar materials to the cladding 104 of the exemplary slat 100 and may fulfill similar purposes and/or requirements.

Referring to FIG. 2a, a lateral cross-sectional view of the modified slat 200 with the core 202 and the cladding 204 in an assembled form is schematically illustrated, in accordance with a modified embodiment of the present disclosure. The slat 200 may be assembled by placing the cladding 204 over the core 202. Specifically, the cladding 204 may be placed such that the first extension 208a may be configured to be received by the first groove 206. The cladding 104 may be impressioned upon the core 202 of the slat 200a, while the hook 220 may be super-imposed over the overhang 210. In an embodiment, the cladding 204 may be held over the core 202 with little or no space therebetween. Further, the cladding 204 and the core 202 may be snuggly fitted together without requiring any additional component.

Now referring to FIGS. 3a to 3e, various perspective views of the core 102 and the cladding 104 in the assembled form are schematically illustrated, in accordance with the embodiment of the present disclosure. The aforementioned figures illustrate the plurality of extensions 108 received by the plurality of grooves 106. It may be evident that there is little or no space left between the plurality of grooves 106 and the plurality of extensions 108. Thus, the assembly of the slat 100 of the present disclosure may not require any additional component such as an adhesive, glue, connector clip, and the like. Further, this may also lead to a longer life of the slat 100 as compared to the slats prepared by using the above mentioned additional components. In FIGS. 3a to 3e, only the exemplary slat 100 is related to, however the same may be relevant to the modified slat 200.

Further referring to FIG. 4, a flow diagram of a method 400 of preparing an exemplary slat 100 and/or a modified slat 200 is schematically illustrated, in accordance with the present disclosure. The method 400 may be explained in conjunction with FIGS. 1a and 2a, as well as with FIGS. 1b and 2b. The method 400 may start at an initial step 402, whereby a raw slat is provided. At a first step 404, at least one groove may be provided in a core of the exemplary slat 100 and/or the modified slat 200. The at least one groove 106a, 206a may be provided along a length of the core 102, 202. The at least one groove may be prepared by slotting the core 102, 202 longitudinally. The core 102, 202 may be made up of a wooden material, a synthetic material, and the like. In an example, the core 102 may be made up of a finger jointed and/or solid material. At a second step 406, at least one extension 108a, 208a in a cladding 104, 204 of the slat 100, 200 may be provided such that the cladding may extend away from the at least one extension. The cladding 104, 204 may be configured to conform to an external outline of the core of the slat 100, 200.

The slat 100 may be assembled by fitting the core and the cladding together. At a third step 408, the cladding may be placed over the core of the slat, such that the slat 100, 200 may be assembled in such a way that the at least one extension 106a, 208a of the cladding 104, 204 may fit in the at least one groove 106a, 206a of the core 102, 202. The cladding may be held by the at least one groove of the core with little or no space therebetween. Accordingly, the cladding and the core may be fixed together without requiring any additional component such as an adhesive, glue, a connector clip, and the like. The method 400 terminates at a final step 412, wherein the assembled slat 100, 200 is removed.

It will be evident to a person skilled in the art that details such as material, structure, and the like of the core and the cladding of the slat 100 have been described with reference to FIG. 1a and have not been described here again for the sake of brevity. Further, the present disclosure may be embodied in other specific forms without departing from its spirit or essential characteristics. The described embodiments are to be considered in all respects only as illustrative and not restrictive.

All directional references (such as, but not limited to, upper, lower, upward, downward, left, right, leftward, rightward, top, bottom, above, below, vertical, horizontal, clockwise, and counterclockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder references (such as, but not limited to, attached, coupled, connected, and the like) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

Similarly, adjectives such as, but not limited to, “articulated”, “modified”, or similar, should be construed broadly, and only as nominal, and may not create any limitations, not create any limitations, particularly as to the description, operation, or use unless specifically set forth in the claims.

While the entire discussion relates to a seated position as a first position, and to a prone position as a second position, the opposite may equally apply, i. e., the patient may be initially positioned in the prone position, and transferred passively to the seated position. Additionally, the patient may be positioned on the therapeutic apparatus in any interim position, and transferred substantially passively to any other position, either any interim position between the seated and prone positions, or the first and second positions themselves.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While certain exemplary embodiments have been described and shown in the accompanying drawings, it is to be understood that such embodiments are merely illustrative of and not restrictive on the broad present disclosure, and that this present disclosure not be limited to the specific constructions and arrangements shown and described, since various other modifications and/or adaptations may occur to those of ordinary skill in the art. It is to be understood that individual features shown or described for one embodiment may be combined with individual features shown or described for another embodiment. It is to be understood some features are shown or described to illustrate the use of the present disclosure in the context of functional elements and such features may be omitted within the scope of the present disclosure and without departing from the spirit of the present disclosure as defined in the appended claims.

1. An article comprising:
a longitudinally extending core having opposing first and second flanks, the first flank comprising at least one groove formed therein, the at least one groove is configured along a length of the core; and
a cladding having at least one extension, the said cladding is configured to conform to the core, wherein
the at least one extension is configured to be received by the at least one groove.

2. The slat of claim 1, wherein the core is made up of a wooden material.

3. The slat of claim 1, wherein the core is made up of a synthetic material.

4. The slat of claim 1, wherein the cladding is made up of a weather-resistant material.

5. The slat of claim 1, wherein the cladding is made up of an aluminum material.

6. The slat of claim 1, wherein the cladding is provided by a sheet of a material selected from a group consisting of plastic, polyvinyl chloride (PVC), acrylic, polycarbonate, and composites thereof.

7. The slat of claim 1, wherein the at least one extension of the cladding is held by the at least one groove of the core with a little space there between.

8. The slat of claim 1, wherein the at least one extension of the cladding is held by the at least one groove of the core with no space therebetween to form a tight fixation between the core and the cladding.

9. The slat of claim 1, wherein the second flank comprises at least one groove formed therein.

10. The slat of claim 1, wherein the second flank comprises at least one overhang formed thereon, and the cladding comprises at least one hook, and wherein the at least one hook at least overlaps the at least one overhang.

11. A method of preparing a slat for a shutter, the method comprising:
providing a core having a first and a second, generally opposing flank;
providing at least one groove in the first flank;
providing at least one extension in a cladding;
placing the cladding over the core, with the at least one extension fitting into the at least one groove.

12. The method of claim 11, wherein the core is made up of a wooden material.

13. The method of claim 11, wherein the core is made up of a synthetic material.

14. The method of claim 11, wherein the cladding is made up of a weather-resistant material.

15. The method of claim 11, wherein the cladding is made up of aluminum material.

16. The method of claim 11, wherein the cladding is provided by a sheet of a material selected from a group consisting of plastic, polyvinyl chloride (PVC), acrylic, polycarbonate, and composites thereof.

17. The method of claim 11, wherein the at least one extension of the cladding is held by the at least one groove of the core with little space therebetween.

18. The method of claim 12, wherein the at least one extension of the cladding is held by the at least one groove of the core with no space therebetween to form a tight fixation between the core and the cladding.

19. The method of claim 11, wherein the second flank is provided with at least one overhang formed thereon, and the cladding is provided with at least one hook, and wherein the at least one hook at least overlaps the at least one overhang.
